(19) United States
(12) Patent Application Publication
(10) Pub. No.: US 2011/0199650 A1
(43) Pub. Date: Aug. 18, 2011

(54) IMAGE PROCESSING APPARATUS,IMAGE PROCESSING CIRCUIT AND IMAGE PROCESSING METHOD

(75) Inventor: Yukio Okamura, Shiojiri-shi (JP)

(73) Assignee: Seiko Epson Corporation, Tokyo (JP)

(21) Appl. No.: 13/027,433

(22) Filed: Feb. 15, 2011

(30) Foreign Application Priority Data
Feb. 15, 2010 (JP) 2010-030261

(51) Int. Cl. H04N 1/40; G06K 9/40

(52) U.S. Cl. 358/444; 382/260

(57) ABSTRACT

An image processing apparatus performs filtering on block image data that is a predetermined region of original image data using a filter having a main scanning width of N and a sub-scanning width of M. Using a register that can shift image data in a plurality of directions, the image processing apparatus processes pixel data columns in a sub-scanning direction included in the block image data in the following manner. The pixel data columns are processed in the sub-scanning direction and a direction opposite to the sub-scanning direction alternately for each of the pixel data columns, and the pixel data columns are also processed in the order in which the columns are aligned in a main scanning direction. This makes shorter the filtering processing time of the image processing apparatus that performs processing on a block-by-block basis.

### BACKGROUND

1. Technical Field

The present invention relates to an image processing technique that processes image data on a block-by-block basis.

2. Related Art

Regarding an image processing apparatus such as a printer, an image scanner, a copier or a multifunction printer, for example, there is known a technique in which image data corresponding to one page (main scanning width W, sub-scanning width H) is divided into blocks (each having a main scanning width of W and a sub-scanning width of L (L: L<H)), so that image data to be processed is obtained, and predetermined image processing (e.g., filtering processing) is performed (e.g., JP-A-2001-251502).

Image data of each block is processed in a sub-scanning direction sequentially from one column (main scanning width 1, sub-scanning width L) of pixel data in the sub-scanning direction to another. When processing of one pixel data column has been completed, a pixel data column adjacent in a main scanning direction to the one pixel data column is subsequently processed.

In JP-A-2001-251502, pixel data to be processed in filtering processing among pixel data contained in a block image, which is taken from original image data stored in a RAM (Random Access Memory), is temporarily stored in a register. Filtering processing is performed using pixel data output from the register.

In JP-A-2001-251502, however, when filtering processing in the sub-scanning direction of one pixel data column has been completed and filtering of the subsequent pixel data column is started, pixel data at the beginning of the latter pixel data column needs to be stored in the register. In other words, pixel data that is stored in the register upon completion of filtering (pixel data at the end of pixel data column on which pixel data filtering has been completed) needs to be removed. Therefore, to start filtering of each pixel data column, pixel data needs to be replaced. This replacement increases the processing time.

### SUMMARY

An advantage of some aspects of the invention is that the filtering processing time is made shorter in an image processing apparatus that performs processing on a block-by-block basis.

According to a first aspect of the invention, an image processing apparatus performs filtering on block image data that is a predetermined region of original image data using a filter having a main scanning width of N and a sub-scanning width of M. In the image processing apparatus, pixel data columns in a sub-scanning direction that are included in the block image data are processed in the sub-scanning direction and a direction opposite to the sub-scanning direction alternately for each of the pixel data columns, and the pixel data columns are also processed in the order in which the columns are aligned in a main scanning direction.

Here, the image processing apparatus may include a memory, a register section having a capacity of N+1 in main scanning width and M in sub-scanning width and made of a shift register capable of shifting stored image data in a plurality of directions, a filter calculation section, and a control section. The memory is configured to store at least part of the block image data. The register section is configured to sequentially acquire and store image data having a main scanning width of N+1 and a sub-scanning width of 1 from the memory and to output image data having a main scanning width of N and a sub-scanning width of M. The filter calculation section is configured to acquire the image data having the main scanning width of N and the sub-scanning width of M from the register section and to perform filtering using the filter. The control section is configured to control a direction of shifting of image data of the register section.

Further, in the image processing apparatus, the memory may store image data of at least N+1 in main scanning width and 2M in sub-scanning width acquired from the block image data. The register section may be capable of shifting in a sub-scanning direction, in a direction opposite to the sub-scanning direction, and in a direction opposite to a main scanning direction, and output the image data having the main scanning width of N and the sub-scanning width of M upon shifting in each of the directions and acquire and store image data from the memory upon shifting in the sub-scanning direction and in the direction opposite to the sub-scanning. The control section may instruct the register to shift in the sub-scanning direction and to shift in the direction opposite to the sub-scanning direction alternately for each of pixel data columns, and instructs the register to shift in the direction opposite to the main scanning direction upon completion of processing of one pixel data column.

According to a second aspect of the invention, an image processing apparatus performs filtering on block image data that is a predetermined region of original image data, using a filter having a main scanning width of N and a sub-scanning width of M. In the image processing apparatus, pixel data columns in a sub-scanning direction that are included in the block image data are processed alternately in the sub-scanning direction and a direction opposite to the sub-scanning direction, and are processed in the order in which the columns are aligned in a main scanning direction.

According to a third aspect of the invention, there is provided an image processing method of performing filtering on block image data that is a predetermined region of original image data using a filter having a main scanning width of N and a sub-scanning width of M. In the image processing method, pixel data columns in a sub-scanning direction that are included in the block image data are processed alternately in the sub-scanning direction and a direction opposite to the sub-scanning direction, and are processed in the order in which the columns are aligned in a main scanning direction.

### BRIEF DESCRIPTION OF THE DRAWINGS

The invention will be described with reference to the accompanying drawings, wherein like numbers reference like elements.

FIG. 1 is a block diagram illustrating a schematic configuration of an image processing apparatus according to one example of an embodiment of the invention.

FIG. 2A illustrates the order of processing of pixel data of a block image.

FIG. 2B illustrates the order of processing of pixel data of a block image.

FIG. 3 illustrates one example of the configuration of a register section.

FIG. 4 illustrates a procedure of storing pixel data in the register section.

FIG. 5 is a flow diagram illustrating the procedure of storing pixel data in the register section.

### DESCRIPTION OF EXEMPLARY EMBODIMENT

An embodiment of the invention is described below with reference to the accompanying drawings.

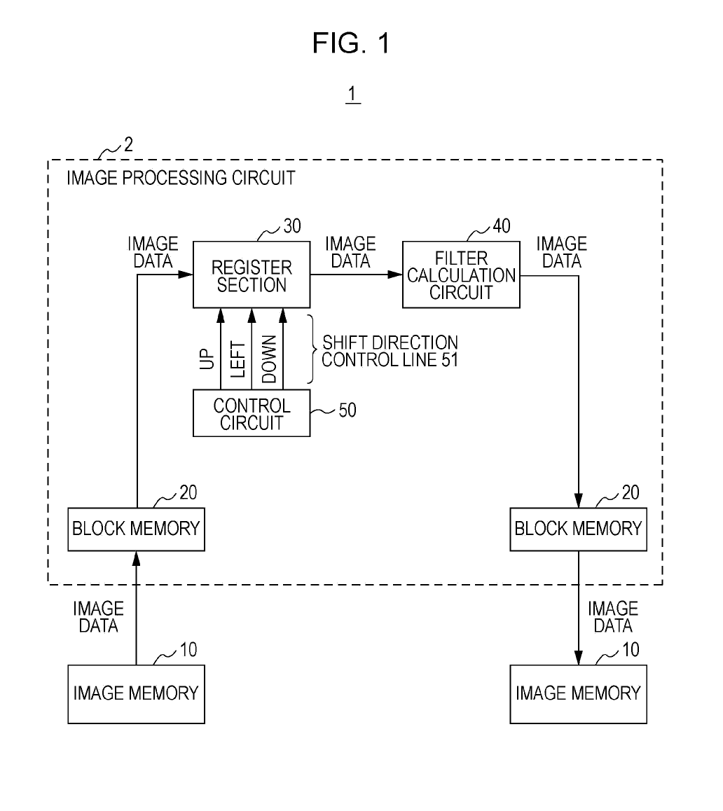

FIG. 1 is a block diagram showing a schematic configuration of an image processing apparatus 1 according to one example of the embodiment of the invention. In the embodiment, processing of a monochrome image is described.

The image processing apparatus 1 is an apparatus having a function of filtering processing on a block-by-block basis. The image processing apparatus 1 is an image processing apparatus such as a printer, an image scanner, a copier or a multifunction printer. In FIG. 1, the configuration related to a filtering process is mainly illustrated. Accordingly, elements having little relation to the filtering processing are omitted.

The image processing apparatus 1 includes an image memory 10, a block memory 20, a register section 30, a filter calculation circuit 40 and a control circuit 50. The block memory 20, the register section 30, the filter calculation circuit 40 and the control circuit 50 together form an image processing circuit 2, such as an ASIC (Application Specific Integrated Circuit), for image processing.

The image memory 10 is a mass storage device configured to store image data, and is, for example, a DDR-SDRAM (Double Data Rate SDRAM). The image memory 10 can store, for example, image data corresponding to one page before filtering processing and one page after the filtering processing.

The block memory 20 is a storage device configured to store at least part of the resultant image data obtained by dividing image data stored in the image memory 10 into blocks, and can be, for example, an SRAM (Static RAM) or a dual-port RAM. The block memory 20 can store both image data before filtering processing and image data after filtering processing.

Input of image data from the image memory 10 to the block memory 20 and output of image data from the block memory 20 to the register section 30 can be performed in a parallel fashion. Accordingly, the block memory 20 needs only to store part of image data of a block image in sequence. As regards the capacity of the block memory 20, for example, in the case where a matrix for use in the filter calculation circuit 40 has a main scanning width of N and a sub-scanning width of M, the capacity can be at least N+1 in main scanning width and 2M in sub-scanning width.

It is to be noted that a block image is stored from the image memory 10 into the block memory 20 and from the block memory 20 into the image memory 10, for example, by control of a CPU (Central Processing Unit)(not illustrated) and DMA (Direct Memory Access)(not illustrated) of the image processing apparatus 1.

Under control of the control circuit 50, the register section 30 outputs pixel data required for filtering processing of one pixel of interest to the filter calculation circuit 40, and stores pixel data required for filtering processing of the subsequent pixel of interest. The register section 30 is made of a shift register, the details of which are to be described later. As regards the capacity of the register section 30, for example, in the case where a matrix for use in the filter calculation circuit 40 has a main scanning width of N and a sub-scanning width of M, the capacity can be N+1 in main scanning width and M in sub-scanning width.

The filter calculation circuit 40 performs filtering processing on pixel data including the pixel of interest output from the register section 30, and outputs a filter calculation result for the pixel of interest to the block memory 20. The matrix used can be, for example, N in main scanning width and M in sub-scanning width.

The control circuit 50 controls input and output of pixel data of the register section 30. The control circuit 50 outputs to the register section 30, for example, a signal indicating the shift direction of the pixel data, in accordance with a predetermined procedure to be described later. Therefore, the control circuit 50 and the register section 30 are connected to each other with a shift direction control line 51 configured to transmit signals of instructions for shifting upward (shifting in a direction opposite to the sub-scanning direction), shifting leftward (shifting in a direction opposite to the main scanning direction) and shifting downward (shifting in the sub-scanning direction).

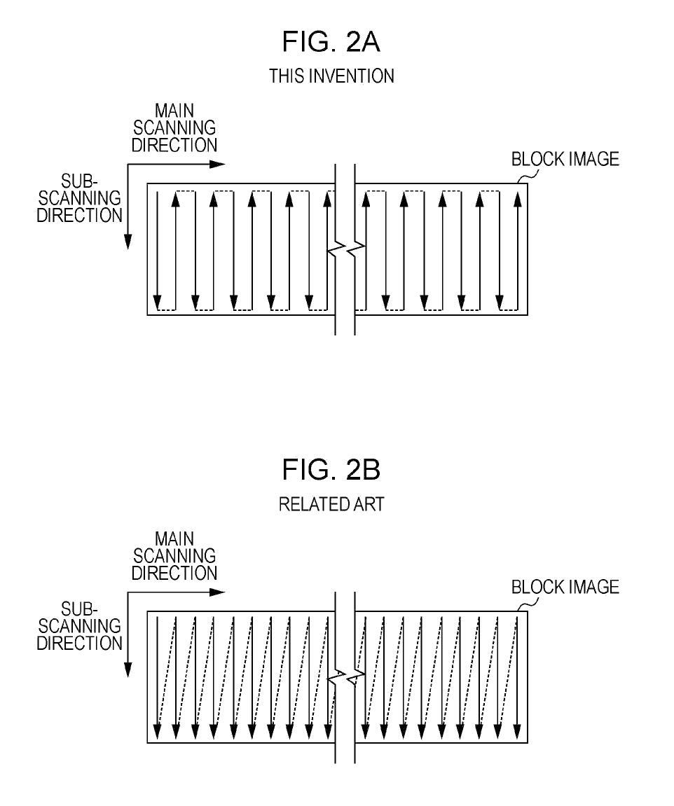

The image processing apparatus 1 of the embodiment configured as described above performs filtering processing on pixels included in a block image in the order as indicated in FIG. 2A. Specifically, columns of pixel data in the sub-scanning direction are sequentially processed in the sub-scanning direction and the direction opposite to the sub-scanning direction alternately for each of the columns. In other words, upon completion of processing on each column, a column adjacent in the main scanning direction to the column on which processing has been completed is processed in a direction opposite to the processing direction (the sub-scanning direction or the direction opposite to the sub-scanning direction) of the column on which processing has been completed.

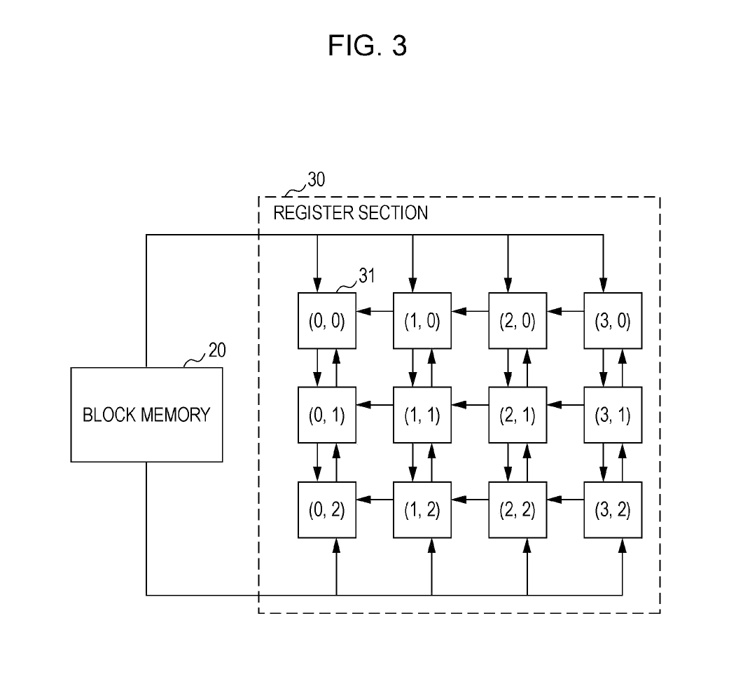

To implement the above-described processing procedure, the register section 30 has a configuration as illustrated in FIG. 3. FIG. 3 illustrates one example of the configuration of the register section 30.

It is to be noted that, in the description given below, the matrix of a filter is assumed to have a main scanning width of N=3 and a sub-scanning width of M=3.

The register section 30 is made of a shift register having a main scanning width of 4 (main scanning positions of 0 to 3) and a sub-scanning width of 3 (sub-scanning positions of 0 to 2). Registers 31 (main scanning positions of 0 to 3, sub-scanning positions of 0 to 2) forming the shift register can shift up, left and down.

Upon shifting down, pixel data from the block memory 20 is loaded and stored in the registers 31 (0 to 3, 0). Upon shifting up, pixel data from the block memory 20 is loaded and stored in the registers 31 (0 to 3, 2). Pixel data of the registers 31 (0 to 2, 0 to 2) is output to the filter calculation circuit 40.

It is to be noted that, as described above, the size of the register section 30 is adapted to the size of a matrix of the filter. In the case where the matrix of the filter has a main scanning width of N and a sub-scanning width of M, the register section 30 has a main scanning width of N+1 and a sub-scanning width of M.

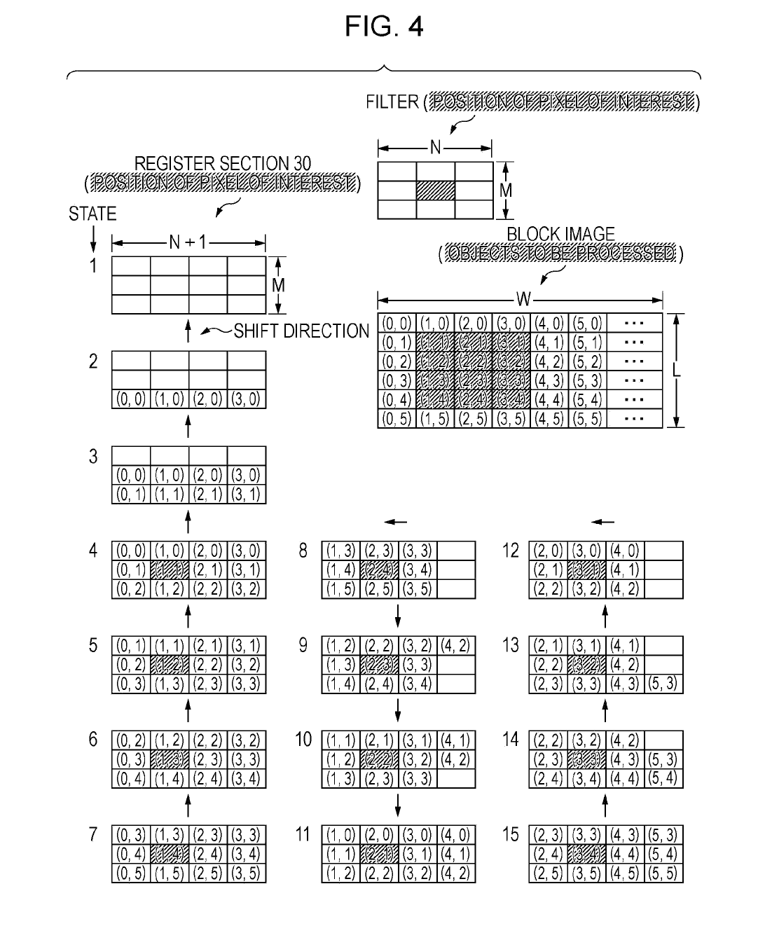

FIG. 4 illustrates a control procedure for storing pixel data in the register section 30. This figure illustrates the case where filtering is performed on objects to be processed (hatched area: pixel data columns (1, 1 to 4), (2, 1 to 4), (3, 1 to 4)) in a block image.

State 1: The register section 30 is empty.

State 2: Upon shifting up, pixel data (0 to 3, 0) is loaded from the block memory 20 into the register section 30.

State 3: Upon shifting up, pixel data (0 to 3, 1) is loaded into the register section 30.

State 4: Upon shifting up, pixel data (0 to 3, 2) is loaded into the register section 30.

State 5: At the timing of shifting up, pixel data (0 to 2, 0 to 2) is output from the register section 30 to the filter calculation circuit 40, and filtering is performed on a pixel of interest (1, 1). Upon shifting up, pixel data (0 to 3, 3) is loaded into the register section 30.

State 6: At the timing of shifting up, pixel data (0 to 2, 1 to 3) is output from the register section 30 to the filter calculation circuit 40, and filtering is performed on a pixel of interest (1, 2). Upon shifting up, pixel data (0 to 3, 4) is loaded into the register section 30.

State 7: At the timing of shifting up, pixel data (0 to 2, 2 to 4) is output from the register section 30 to the filter calculation circuit 40, and filtering is performed on a pixel of interest (1, 3). Upon shifting up, pixel data (0 to 3, 5) is loaded into the register section 30.

State 8: At the timing of shifting left, pixel data (0 to 2, 3 to 5) is output from the register section 30 to the filter calculation circuit 40, and filtering is performed on a pixel of interest (1, 4). Upon shifting left, the registers 31 (3, 0 to 2) of the register section 30 become empty.

State 9: At the timing of shifting down, pixel data (1 to 3, 3 to 5) is output from the register section 30 to the filter calculation circuit 40, and filtering is performed on a pixel of interest (2, 4). Upon shifting down, pixel data (1 to 4, 2) is loaded into the register section 30.

State 10: At the timing of shifting down, pixel data (1 to 3, 2 to 4) is output from the register section 30 to the filter calculation circuit 40, and filtering is performed on a pixel of interest (2, 3). Upon shifting down, pixel data (1 to 4, 1) is loaded into the register section 30.

State 11: At the timing of shifting down, pixel data (1 to 3, 1 to 3) is output from the register section 30 to the filter calculation circuit 40, and filtering is performed on a pixel of interest (2, 2). Upon shifting down, pixel data (1 to 4, 0) is loaded into the register section 30.

State 12: At the timing of shifting left, pixel data (1 to 3, 0 to 2) is output from the register section 30 to the filter calculation circuit 40, and filtering is performed on a pixel of interest (2, 1). Upon shifting left, the registers 31 (3, 0 to 2) of the register section 30 become empty.

State 13: At the timing of shifting up, pixel data (2 to 4, 0 to 2) is output from the register section 30 to the filter calculation circuit 40, and filtering is performed on a pixel of interest (3, 1). Upon shifting up, pixel data (2 to 5, 3) is loaded into the register section 30.

State 14: At the timing of shifting up, pixel data (2 to 4, 1 to 3) is output from the register section 30 to the filter calculation circuit 40, and filtering is performed on a pixel of interest (3, 2). Upon shifting up, pixel data (2 to 5, 4) is loaded into the register section 30.

State 15: At the timing of shifting up, pixel data (2 to 4, 2 to 4) is output from the register section 30 to the filter calculation circuit 40, and filtering is performed on a pixel of interest (3, 3). Upon shifting up, pixel data (2 to 5, 5) is loaded into the register section 30.

The foregoing configurations of the image processing apparatus 1 and the image processing circuit 2 are main configurations used for describing features of the invention, and the invention is not limited to the foregoing configurations. The foregoing configurations are not meant to be exclusive of other configurations included in typical image processing apparatuses and image processing circuits. The foregoing elements are classified in accordance with the main contents of processing for ease of understanding. The manner in which elements are classified and their names are not limited to those described in the embodiment of the invention. The configurations of the image processing apparatus 1 and the image processing circuit 2 can be further classified into more elements in accordance with the contents of processing. Additionally, classification can be made such that one element carries out more processes. Additionally, the processing of each element may be performed by one hardware device or may be performed by a plurality of hardware devices.

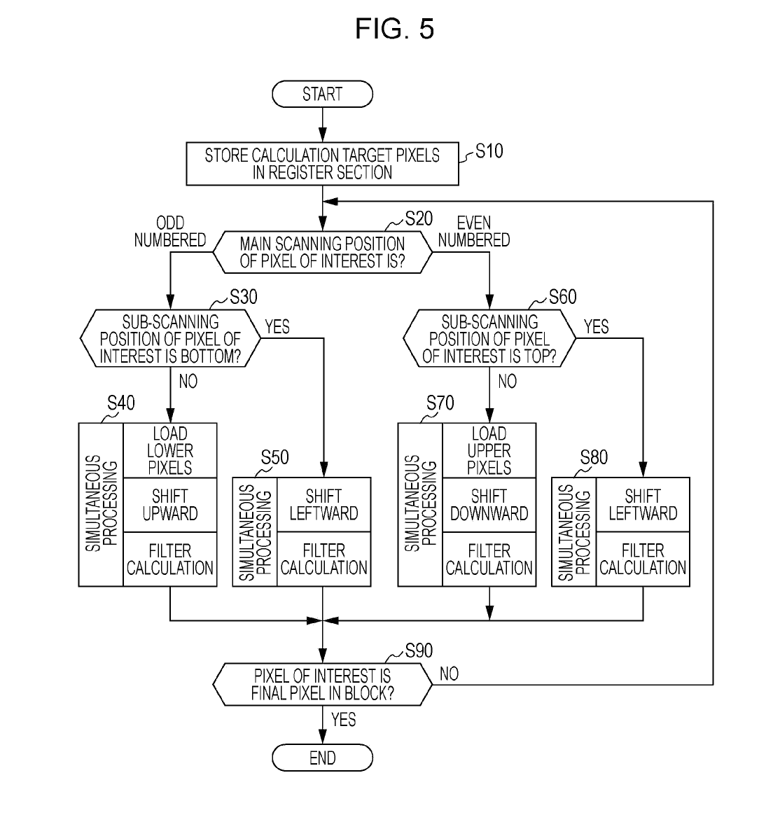

FIG. 5 is a flow diagram illustrating a control procedure for storing image data in the register section 30. This flow starts, for example, when an instruction to start filtering processing of image data of one block is given.

In S10, a pixel on which a filtering calculation is to be performed is stored in the register section 30. Specifically, the control circuit 50 outputs a shifting-up or shifting-down signal three times, so that the register section 30 is filled with pixel data to be used for processing of the initial pixel of interest. For example, as illustrated in FIG. 4, in the case where filtering starts downward from the column having a main scanning position of 1, the control circuit 50 outputs a shifting-up signal to cause the register section 30 to be in State 4. Then, the control circuit 50 causes the process to proceed to S20.

In S20, the control circuit 50 determines whether the main scanning position of the pixel of interest is odd numbered or even numbered. Specifically, it is determined whether the position in the main scanning direction of the pixel of interest in the block image is odd numbered (1, 3, 5 . . . ) or even numbered (0, 2, 4 . . . ). For example, in the case of the block image of FIG. 4, the main scanning positions of pixel data (1, 1) and (3, 1) are odd numbered, and the main scanning position of pixel data (2, 1) is even numbered. If the main scanning position of the pixel of interest is odd numbered (S20: odd numbered), the process proceeds to S30. If the main scanning position of the pixel of interest is even numbered (S20: even numbered), the process proceeds to S60.

In S30, the control circuit 50 determines whether the sub-scanning position (line position) of the pixel of interest is at the bottom. Specifically, it is determined whether the pixel of interest is the lowermost pixel of pixel data to be processed as pixels of interest in the pixel data column. For example, in the case of the block image of FIG. 4, pixel data (1, 4) corresponds to the bottom pixel. If the sub-scanning position of the pixel of interest is at the bottom (S30: YES), the process proceeds to S50. If the sub-scanning position of the pixel of interest is not at the bottom (S30: NO), the process proceeds to S40.

In S40, the control circuit 50 outputs a shifting-up signal. With this shifting-up signal as an impetus, the subsequent pixel data row that is adjacent in the sub-scanning direction to the pixel data row (main scanning direction) currently stored at the bottom of the register section 30 is loaded from the block memory 20 into the register section 30. Simultaneously, each pixel data row currently stored in the register section 30 is shifted upward, and pixel data stored in the registers 31 (0 to 2, 0 to 2) is output to the filter calculation circuit 40. At this point, the loaded pixel data row is stored in the bottom row of the register section 30. Also, simultaneously, using the pixel data output from the register section 30, a filter calculation is performed on the pixel of interest by the filter calculation circuit 40. Then, the control circuit 50 causes the process to proceed to S90.

In S50, the control circuit 50 outputs a shifting-left signal. With this shifting-left signal as an impetus, each pixel data column currently stored in the register section 30 is shifted leftward, and the pixel data stored in the registers 31 (0 to 2, 0 to 2) is output to the filter calculation circuit 40. At this point, the rightmost column of the register section 30 becomes empty. Also, simultaneously, using the pixel data output from the register section 30, a filter calculation is performed on the pixel of interest by the filter calculation circuit 40. Then, the control circuit 50 causes the process to proceed to S90.

In S60, the control circuit 50 determines whether the sub-scanning position (line position) of the pixel of interest is at the top. Specifically, it is determined whether the pixel of interest is the uppermost pixel of pixel data to be processed as pixels of interest in the pixel data column. For example, in the case of the block image of FIG. 4, pixel data (2, 1) corresponds to the top pixel. If the sub-scanning position of the pixel of interest is at the top (S60: YES), the process proceeds to S80. If the sub-scanning position of the pixel of interest is not at the top (S60: NO), the process proceeds to S70.

In S70, the control circuit 50 outputs a shifting-down signal. With this shifting-down signal as an impetus, the subsequent pixel data row that is adjacent, in the direction opposite to the sub-scanning direction, to the pixel data row (main scanning direction) currently stored at the top of the register section 30 is loaded from the block memory 20 into the register section 30. Simultaneously, each pixel data row currently stored in the register section 30 is shifted downward, and pixel data stored in the registers 31 (0 to 2, 0 to 2) is output to the filter calculation circuit 40. At this point, the loaded pixel data row is stored in the top row of the register section 30. Also, simultaneously, using the pixel data output from the register section 30, a filter calculation is performed on the pixel of interest by the filter calculation circuit 40. Then, the control circuit 50 causes the process to proceed to S90.

In S80, the control circuit 50 outputs a shifting-left signal. This processing is similar to that of S50.

In S90, the control circuit 50 determines whether the pixel of interest is the final pixel in the block image data. Specifically, the control circuit 50 determines whether the pixel of interest on which filtering has been performed in S40, S50, S70 or S80 is the final pixel data for filtering in the block image data. If that pixel of interest is not the final pixel (S90: NO), the control circuit 50 restores the process to S20. If the pixel of interest is the final pixel (S90: YES), the control circuit 50 ends the flow.

It is to be noted that, at the time when the flow ends, if a subsequent block image exists, the process of the flow starts for that block image.

The foregoing processing units illustrated in FIG. 4 and FIG. 5 are obtained by dividing processing of the image processing apparatus 1 and the image processing circuit 2 in accordance with the main contents of processing for ease of understanding. The manner in which processing is divided into processing units and their names are not limited to those described in the embodiment of the invention. The processing of the image processing apparatus 1 and the image processing circuit 2 can be divided into more processing units in accordance with the contents of processing. Additionally, division can be performed such that one processing unit includes more processes.

It is to be noted that while, in the foregoing embodiment, odd numbered columns of a block image are processed in the sub-scanning direction (processing by shifting up (in the direction opposite to the sub-scanning direction)) and even numbered columns are processed in the direction opposite to the sub-scanning direction (processing by shifting down (sub-scanning direction)), the opposite may be performed.

An embodiment of the invention has been described above. According to the embodiment, the filtering processing time can be made shorter in an image processing apparatus in which processing is performed on a block-by-block basis.

In other words, according to the embodiment, while remaining stored in the register section 30, pixel data at the beginning or at the end of the pixel data column, which has been used for filtering, is reused for filtering of the beginning or the end of the subsequent pixel data column. Such a structure eliminates the need for replacing all of pixel data in order to start filtering processing of each pixel data column. Thus, the filtering processing time is reduced.

The foregoing embodiment of the invention is intended to be illustrative, but not restrictive, of the spirit and scope of the invention. Many alternatives, modifications and variations will be apparent to those skilled in the art.

For example, the invention is applicable to processing of a color image. Specifically, an image memory and a block memory are configured to be able to store image data of three colors of RGB (red, green and blue). A register section and a filter calculation circuit are provided for each of RGB. A control circuit controls the register sections for RGB. As a matter of course, one filter calculation section shareable among RGB may be provided.

The entire disclosure of Japanese Patent Application Nos. 2010-30261, filed Feb. 15, 2010 are expressly incorporated by reference herein.

What is claimed is:

1. An image processing apparatus that performs filtering on block image data that is a predetermined region of original image data, comprising:
a memory configured to store at least part of the block image data;
a register section having a capacity of N+1 in main scanning width and M in sub-scanning width and made of a shift register capable of shifting stored image data in a plurality of directions, the register section being configured to sequentially acquire and store image data having a main scanning width of N+1 and a sub-scanning width of 1 from the memory and to output image data having a main scanning width of N and a sub-scanning width of M;
a filter calculation section configured to acquire the image data having the main scanning width of N and the sub-scanning width of M from the register section and to perform filtering using a filter; and
a control section configured to control a direction of shifting of image data of the register section.

2. The image processing apparatus according to claim 1, wherein
the memory stores image data of at least N+1 in main scanning width and 2M in sub-scanning width acquired from the block image data,
the register section is capable of shifting in a sub-scanning direction, in a direction opposite to the sub-scanning direction and in a direction opposite to a main scanning direction, and outputs the image data having the main scanning width of N and the sub-scanning width of M upon shifting in each of the directions and acquires and stores image data from the memory upon shifting in the sub-scanning direction and in the direction opposite to the sub-scanning direction, and
the control section instructs the register to shift in the sub-scanning direction and to shift in the direction opposite to the sub-scanning direction alternately for each of pixel data columns, and instructs the register to shift in the direction opposite to the main scanning direction upon completion of processing of one pixel data column.

3. An image processing circuit that performs filtering on block image data that is a predetermined region of original image data, comprising:
a memory configured to store at least part of the block image data;
a register section having a capacity of N+1 in main scanning width and M in sub-scanning width and made of a shift register capable of shifting stored image data in a plurality of directions, the register section being configured to sequentially acquire and store image data having a main scanning width of N+1 and a sub-scanning width of 1 from the memory and to output image data having a main scanning width of N and a sub-scanning width of M;
a filter calculation section configured to acquire the image data having the main scanning width of N and the sub-scanning width of M from the register section and to perform filtering using a filter; and
a control section configured to control a direction of shifting of image data of the register section.

4. An image processing method of performing filtering on block image data that is a predetermined region of original image data, comprising:
sequentially acquiring and storing image data having a main scanning width of N+1 and a sub-scanning width of 1 from a memory configured to store at least part of the block image data, and outputting image data having a main scanning width of N and a sub-scanning width of M;
acquiring the image data having the main scanning width of N and the sub-scanning width of M from a shift register having a capacity of N+1 in main scanning width and M in sub-scanning width and being capable of shifting stored image data in a plurality of directions, and performing filtering using a filter; and
controlling a direction of shifting of image data of the register.
